(19) United States
(12) Patent Application Publication
(10) Pub. No.: US 2024/0334877 A1
(43) Pub. Date: Oct. 10, 2024

(54) EMBODIMENT DEVICE INTRODUCED IN TRACK CYLINDERS FOR GRAIN HARVESTING AND PROCESSING MACHINES

(71) Applicant: INDÚSTRIAS COLOMBO S.A., Pindorama (BR)

(72) Inventors: Oswaldo Argeu LEITE, Catanduva (BR); Alexandre Aparecido CRESCIO, Pindorama (BR); João Carlos VOLPI, Roberto (BR)

(21) Appl. No.: 18/604,617

(22) Filed: Mar. 14, 2024

(30) Foreign Application Priority Data
Apr. 5, 2023 (BR) 102023006353-5

(51) Int. Cl. A01F 12/22; A01F 7/06

(52) U.S. Cl. CPC A01F 12/22; A01F 7/067

(57) ABSTRACT

An embodiment introduced in track cylinders of grain harvesting and processing machines, including reinforcements obtained by casting applied to an inlet region for harvested material at helical portions of a feeding, a distributor and track cylinders; and beater fingers, applied to a helical portion of a track cylinder incorporating, at least one flat lengthwise band, where height markings are located, allowing standardized regulation of their heights.

### FIELD OF APPLICATION

An embodiment device as introduced in track cylinders of grain harvesting and processing machines, included in the mechanical and agronomical engineering field.

### SUMMARY OF THE INVENTION

As known by the experts in the art, the track system for grain harvesting and processing machines is basically constituted by the following subsets:
a collecting roller, to receive the material from the ground, which is assembled to the front of the harvester, adjustable over the ground;
a feeding cylinder, incorporating a helical portion to receive the material as collected by the colleting roller and transport it to the inner part of the machine for processing;
a distributor cylinder, used in a device having at least one track cylinder, guiding the product originated from the feeding cylinder to each track cylinder;
a track cylinder, incorporating a helical portion provided with beater fingers, transporting the harvested product while separating grains from the straw and stalks;
a grain separator, constituted by one or more sieves having various sections with openings in different sizes, to separate grains from residues;
a fan to remove straw and lighter residues, using an air flow to blow them to outside the harvester; and
a grain box to store clean grains, with capacity to hold a large quantity and which may be unloaded when full.

Patents documents BR102013015624-8, BR102015007088-8, BR102017005429-2, BR102018000597-9, BR102018004944-5, BR102020001478-1 and BR102020001493-5 show examples of grain harvesters and processers, all of which are included herein as reference.

### TECHNICAL BACKGROUND

The feeding, distributor and track cylinders for the currently known grain harvesters has, as one of their main inconveniences, premature wearing of the helical portions, with a few hours of work.

The helical portions are substituted with difficulty, since they are welded to the cylinders. This increases maintenance time, since the machine should be disassembled to remove the cylinders, take out the worn helical portions and weld a new one in place.

In an attempt to delay such wearing, a 7.94 mm ( 5/16″) diameter shaft has been welded along the whole edge of the helical portion, but its increased working life is still insufficient to avoid non-scheduled stops to repair the component.

The beater fingers, located along the helical portion of the track cylinder, are usually cylindrical and knurled. They are produced with steel 1020 and their treatment is long and expensive. Even so, for being in continued contact with the harvested material, besides wearing, they get deformed, which may result in damage e.g. for the concave portion involving the track cylinder.

The standard regulation of the beater fingers is also difficult, since, besides not having markings to regulate their height, their cylindrical conformation also forbids their location in an adequate position to observe their markings.

It thus becomes desirable to propose a solution to overcome the inconveniences of the state of the art, concerning the wear and tear of the helical portions of the feeding, distributor and track cylinders, and wearing and deformation of the beater fingers of the track cylinders.

### SUMMARY OF THE INVENTION

Aiming to overcome the inconveniences of the state of the art, The claimed invention seeks to provide for the helical portions, in the inlet region for the materials into the feeding, distributor and track cylinders, where there is stronger wearing, the adoption of reinforcements, produced by casting from a unique material to delay wearing.

To allow the reinforcements to be substituted more easily upon wearing, these will be screwed to the helical portion, reducing maintenance time.

The beater fingers of the track cylinder helical portions, which are now cast from a unique material to delay their wearing and deformation, and now have, at least, a flat lengthwise band including height markings, may also have a triangular, quadrangular, pentagonal, hexagonal or any other multifaceted shape, so to allow them all to be positioned so to enable marking visualization, thus allowing the standardized regulation of their height.

Among the benefits reached by the proposed embodiment devices, we highlight:
delay in wearing for the helical portions and the beater fingers;
avoiding beater finger deformation;
easy helical portion substitution and maintenance; less stop time for helical portion maintenance;
easy height regulation for the beater fingers in the field; and
less stop time to regulate the beater fingers.

### BRIEF DESCRIPTION OF DRAWINGS

FIG. 1 shows a perspective view of a track cylinder of the state of the art;

FIG. 2 shows an enlarged view of the detail A of FIG. 1;

FIG. 3 shows a perspective view from another angle of a track cylinder of the state of the art;

FIG. 4 shows an enlarged view of the detail B of FIG. 3;

FIG. 5 shows the same perspective view of FIG. 1, with the reinforcements of the invention as applied to the helical portions of the track cylinder;

FIG. 6 shows an enlarged view of the detail A of FIG. 4;

FIG. 7 shows an exploded perspective view of the reinforcements of the invention as applied to the helical portion of the track cylinder;

FIG. 8 shows a perspective view of a distributor cylinder of the state of the art;

FIG. 9 shows an exploded perspective view of the reinforcements of the invention to be applied to the helical portion of a track cylinder of the state of the art;

FIG. 10 shows the same perspective view of the reinforcements of the invention, as applied to the helical portion of the distributor cylinder;

FIG. 11 shows an enlarged exploded perspective view of the reinforcements of the invention to be applied to the helical portion of the distributor cylinder;

FIG. 12 shows a perspective view of a feeding cylinder of the state of the art;

FIG. 13 shows an enlarged view of the detail A of FIG. 12;

FIG. 14 shows an enlarged view of the detail B of FIG. 12;

FIG. 15 shows an exploded perspective view of the reinforcements of the invention to be applied to the helical portion of a feeding cylinder of the state of the art;

FIG. 16 shows the same perspective view of the reinforcements of the invention, as applied to the helical portion of the feeding cylinder;

FIG. 17 shows an enlarged view of the detail A of FIG. 16;

FIG. 18 shows an enlarged view of the detail B of FIG. 16;

FIG. 19 shows an enlarged exploded perspective view of the reinforcements of the invention to be applied to the helical portion of the feeding cylinder;

FIG. 20 shows a perspective view of the feeding, distributor and track cylinder set incorporating the reinforcements of the invention;

FIG. 21 shows a front view of the feeding, distributor and track cylinder set incorporating the reinforcements of the invention;

FIG. 22 shows a side view of the feeding, distributor and track cylinder set incorporating the reinforcements of the invention;

FIG. 23 shows an upper view of the feeding, distributor and track cylinder set incorporating the reinforcements of the invention;

FIG. 24 shows a perspective view of a beater finger of the state of the art as used in a helical portion of a track cylinder of the state of the art;

FIG. 25 shows a perspective view of a beater finger of the invention with a flat lengthwise band where height markings and the neutral position are located; and

FIG. 26 shows an enlarged view of the detail A of FIG. 25.

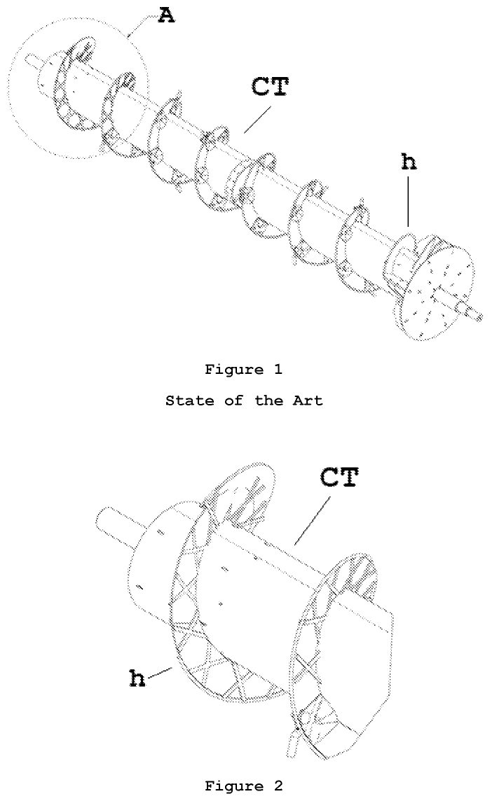

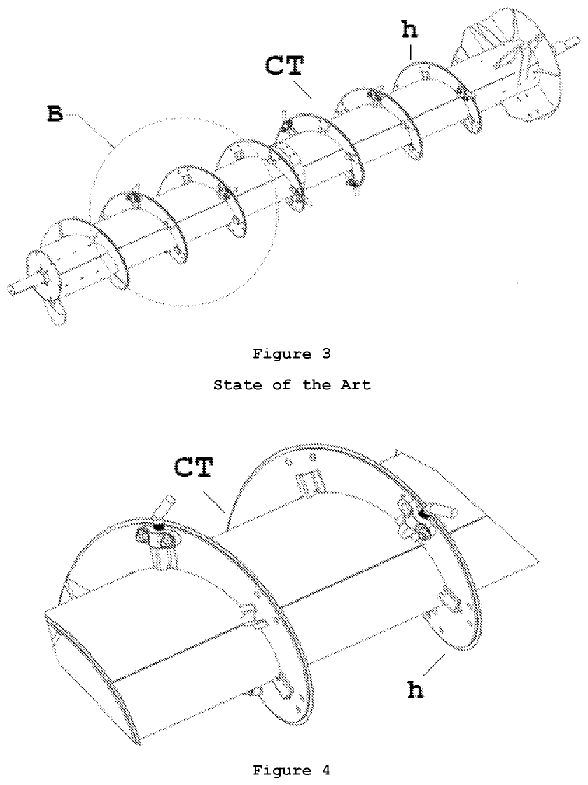

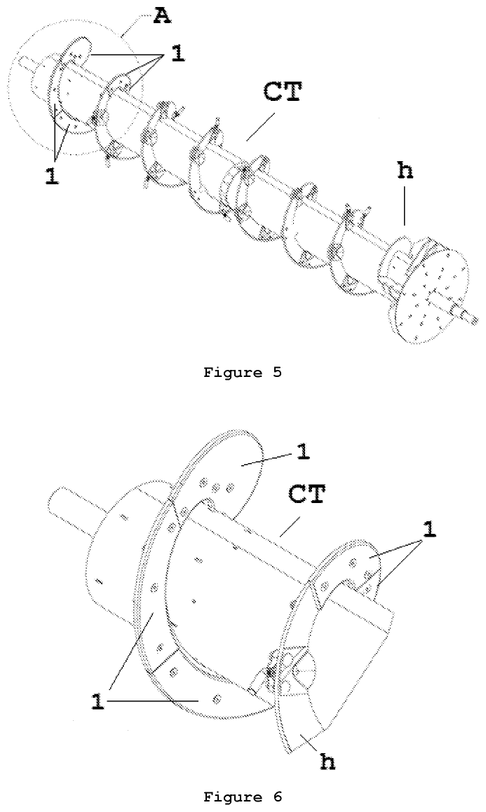

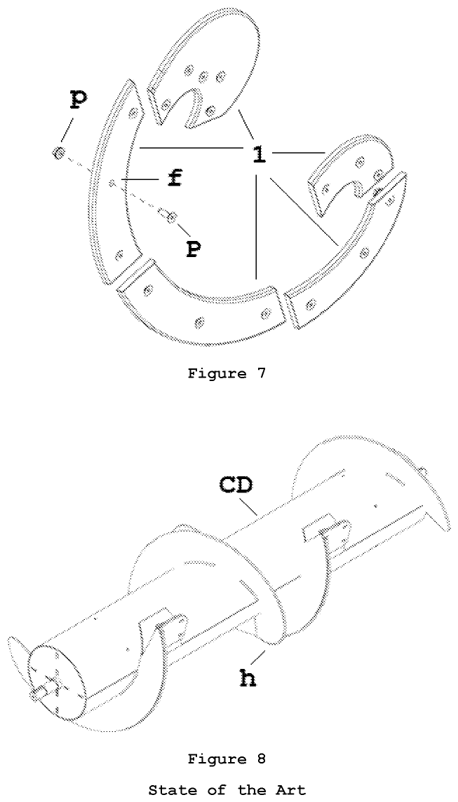

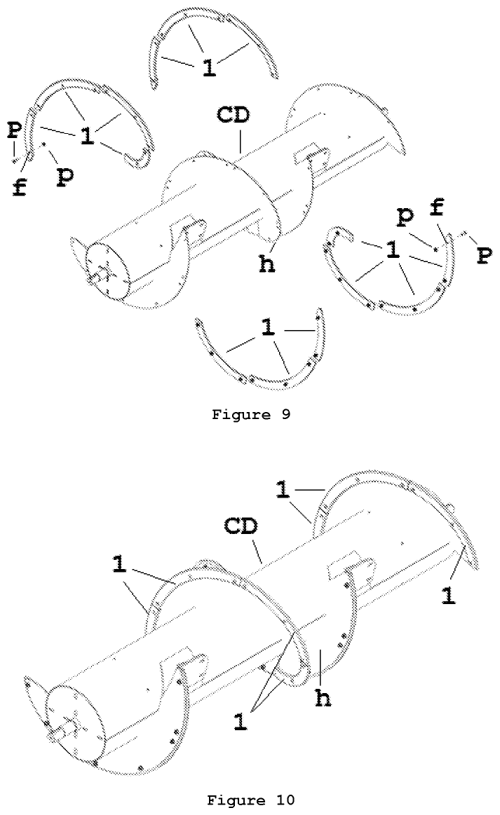

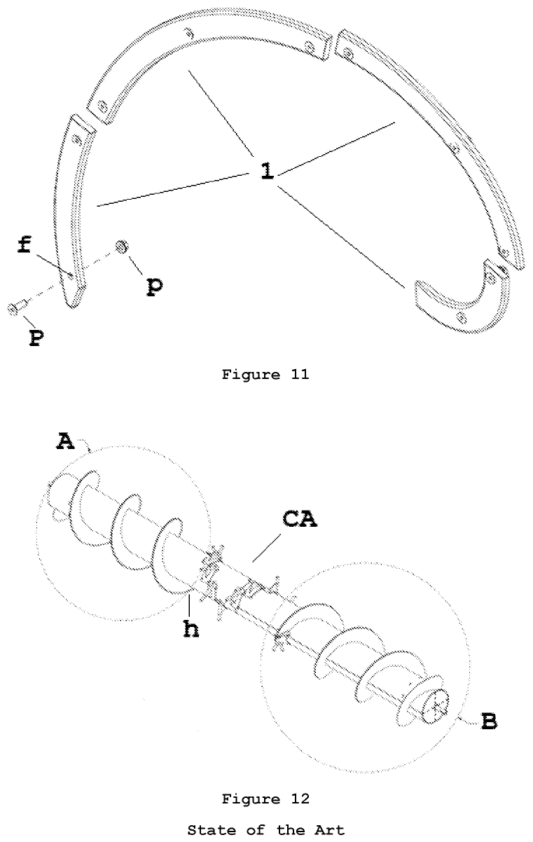

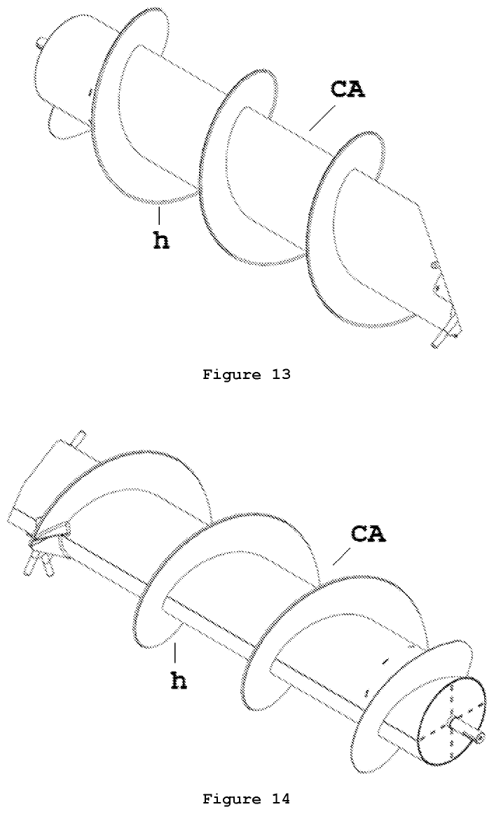

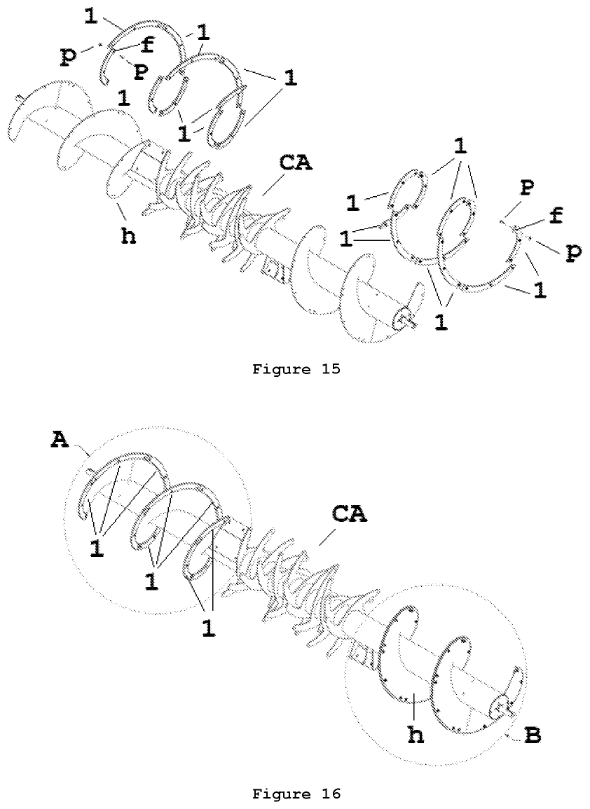

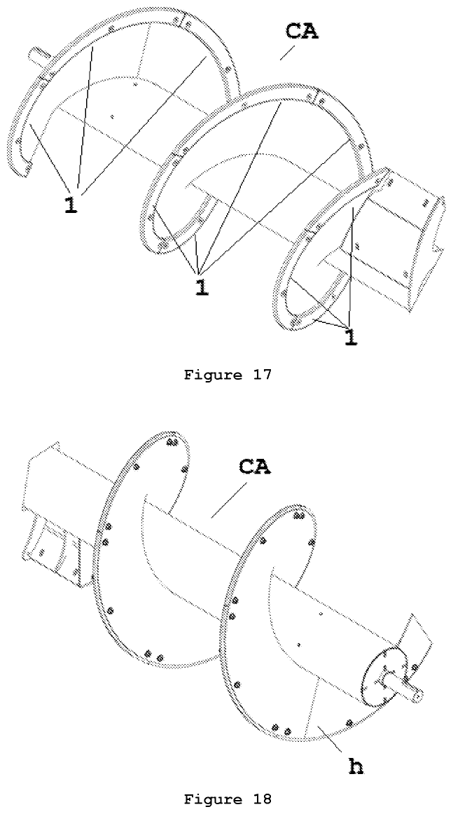

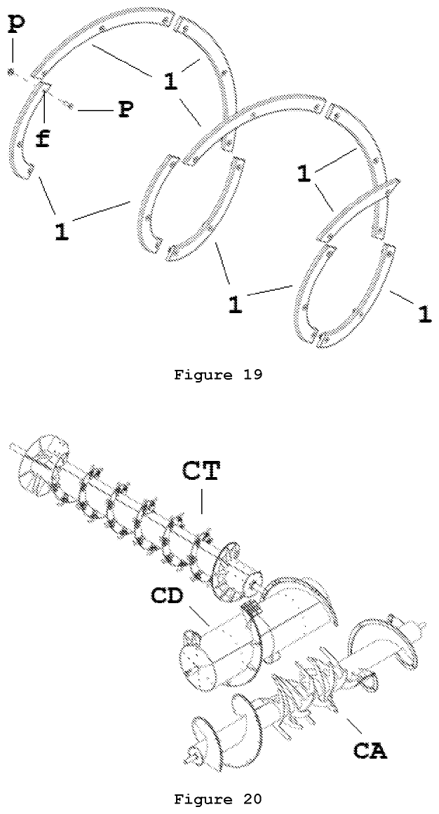

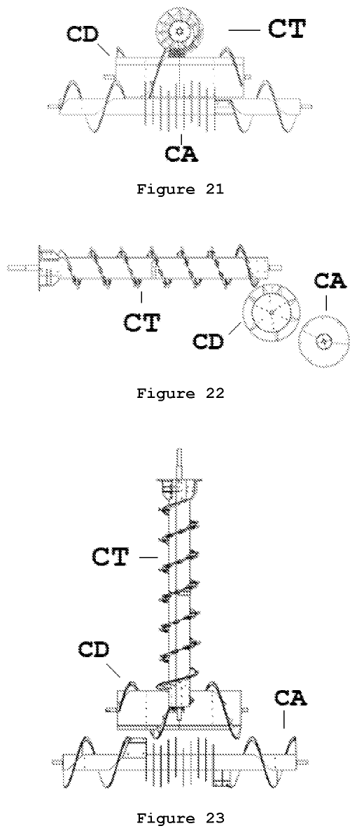

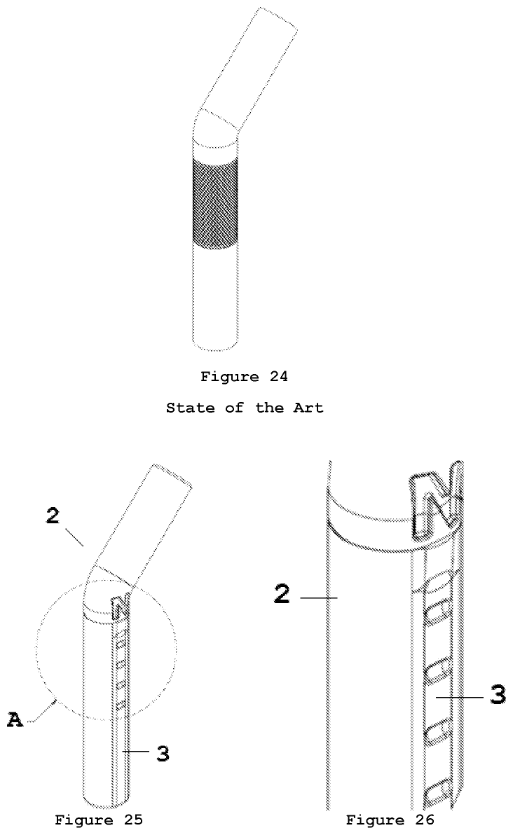

### PREFERRED EMBODIMENT OF THE INVENTION

To overcome the inconveniences of the state of the art, reinforcements (1), manufactured by casting from an appropriate material for this purpose, are applied at the inlet region for the harvested material in the helical portions (h) of the feeding (CA), distributor (CD) and track (CT) cylinders, said reinforcements fixed to the helical portions by screws (P) and nuts (p) to facilitate their substitution when worn, thus reducing maintenance time, wherein screw heads are placed close to the edges of the holes (f) to which they are installed, so to avoid their wearing.

Since they are manufactured by casting, beater fingers (2) do not get deformed, thus avoiding damage e.g. to the concave portion, besides improving its wearing resistance.

The beater fingers now also incorporate, at least, a flat lengthwise band (3), wherein height markings are located, and their contour may have a triangular, quadrangular, pentagonal, hexagonal or any other multifaceted shape, allowing them all to be located so to enable marking visualization, thus allowing their standardized height regulation.

1. An embodiment introduced in track cylinders of grain harvesting and processing machines, including reinforcements applied to an inlet region for harvested material at helical portions of a feeding, a distributor and track cylinders.

2. The embodiment of claim 1, wherein the reinforcements are manufactured by casting.

3. The embodiment of claim 1, wherein the reinforcements are fixed to the helical portions by screws and nuts.

4. The embodiment of claim 3, wherein heads screws are installed adjacent to edges of holes where they are installed.

5. An embodiment introduced in track cylinders of grain harvesting and processing machines, wherein beater fingers, applied to a helical portion of a track cylinder incorporating, at least one flat lengthwise band, where height markings are located.

6. The embodiment of claim 5, wherein the contour of the beater fingers is triangular shape.

7. The embodiment of claim 5, wherein the contour of the beater fingers is quadrangular shape.

8. The embodiment of claim 5, wherein the contour of the beater fingers is pentagonal shape.

9. The embodiment of claim 5, wherein the contour of the beater fingers is hexagonal shape.

10. The embodiment of claim 5, wherein the contour of the beater fingers is multifaceted shape.

11. The embodiment of claim 5, wherein the beater fingers are manufactured by casting.
